(19) United States
(12) Patent Application Publication
(10) Pub. No.: US 2007/0209629 A1
(43) Pub. Date: Sep. 13, 2007

(54) Connecting Rod and Method for Production Thereof

(75) Inventors: Kazuo Minemura, Tochigi-ken (JP); Yasuo Momose, Tochigi-ken (JP)

Correspondence Address: BIRCH STEWART KOLASCH & BIRCH, PO BOX 747, FALLS CHURCH, VA, 22040-0747, US

(73) Assignee: HONDA MOTOR CO., LTD., TOKYO JAPAN (JP)

(21) Appl. No.: 11/578,702

(22) PCT Filed: Apr. 25, 2005
(86) PCT No.: PCT/JP05/07782

§ 371 Date: Oct. 17, 2006

(30) Foreign Application Priority Data
Apr. 26, 2004 (JP) 2004-129950

(51) Int. Cl. F16C 7/00

(52) U.S. Cl. 123/197.3

(57) ABSTRACT

A method for producing s connecting rod, wherein the vicinity of the bottom portion of a notch, which is planed to be broken in a pre-formed article for the connecting rod, is irradiated with a laser light, a plasma or the like, and when the irradiated bottom portion is allowed to cool in air, an austenite structure is transformed into a martensite structure, which results in the formation of a martensite portion in the vicinity of the bottom portion of a notch.

### TECHNICAL FIELD

The present invention relates to a connecting rod having a cap that is provided by fracturing the large end thereof and a main body joined to the cap, and a method of manufacturing such a connecting rod.

### BACKGROUND ART

As shown in FIG. 6, an end of a connecting rod 1 has a first through hole 2 defined therein, and the other end thereof has a second through hole 3 defined therein which is smaller in diameter than the first through hole 2. Generally, the end with the first through hole 2 is referred to as a large end 4, and the other end with the second through hole 3 as a small end 5. The large end 4 and the small end 5 are connected to each other by an elongate shank 6.

The large end 4 of the connecting rod 1 is fractured substantially centrally across the first through hole 2 at notches N, N serving as a boundary in a direction (Y direction) perpendicular to the longitudinal direction (X direction in FIG. 7) of the connecting rod 1, thereby dividing the connecting rod 1 into a cap 7 and a main body 8 (see FIG. 6). The cap 7 and the main body 8 are connected to each other by bolts, not shown, inserted through bolt holes 9.

A journal of a crankshaft is supported in the first through hole 2 of the connecting rod 1 with a bearing interposed therebetween. A piston pin of an internal combustion engine is inserted in the second through hole 3 with another bearing interposed therebetween. The piston pin is inserted in a piston. Therefore, the connecting rod 1 serves as a member interconnecting the piston of the internal combustion engine and the crankshaft and performs a function to transmit the rotational drive force of the crankshaft to the piston.

The connecting rod 1 of this kind is manufactured by forging a preform PR where the cap 7 and the main body 8 are integrally formed in one member, thereafter fracturing the preform PM from the notches N, N into the cap 7 and the main body 8, and then connecting the cap 7 and the main body 8 to each other with bolts inserted through the bolt holes 9 (see Patent Documents 1 through 3).

When the preform PR are divided into the cap 7 and the main body 8, the large end 4 may not always start to be fractured from the notches N, but may start to be fractured from regions other than the notches N. In the event of such a fracture, since the notches N remain in the connecting rod 1, there are concerns for the fracture starting from the notches N when the connecting rod 1 is installed and used in an internal combustion engine.

Therefore, the preform PR that has been fractured from other regions than the notches N will not be used as the connecting rod 1. As a consequence, the fabrication yield of connecting rods 1 is lowered.

Patent Document 4 proposes that hydrogen be dispersed in the vicinity of the notches to cause a hydrogen-induced brittle failure which tends to give rise to brittle fractures in the vicinity of the notches.

Patent Document 5 proposes that outwardly projecting protrusions be provided in to-be-fractured regions, and then compressed to make the to-be-fractured regions harder than other regions, after which the workpiece is fractured from the to-be-fractured regions.

Patent Document 1: Japanese Laid-Open Patent Publication No. 61-21414;

Patent Document 2: Japanese Patent Publication No. 3-18053;

Patent Document 3: Japanese Laid-Open Patent Publication No. 64-64729;

Patent Document 4: Japanese Laid-Open Patent Publication No. 11-108039; and

Patent Document 5: Japanese Laid-Open Patent Publication No. 6-99318.

### DISCLOSURE OF THE INVENTION

### Problems to be Solved by the Invention

According to the technology disclosed in Patent Document 4, since it is difficult to prevent hydrogen from entering other regions than the notches, regions other than the fractured regions of the connecting rod tend to become brittle, resulting in a reduction in the mechanical strength of the connecting rod.

According to the technology disclosed in Patent Document 5, the step of providing the protrusions and the step of compressing the protrusions need to be performed. Therefore, the process is complex and lowers the efficiency with which to produce the connecting rod.

The preform has a generally large thickness. Even if notches are formed in the preform, a large fracture load is required to divide the large end. Consequently, the fracturing apparatus itself is large in size, and requires a large investment in facilities.

One solution would be to increase the depth of the notches. However, since the area of contact between the main body and the cap would be reduced by the increased notch depth, the main body and the cap would be connected to each other with reduced strength.

It is a general object of the present invention to provide a connecting rod which has a large area of contact between a cap and a main body.

A main object of the present invention is to provide a connecting rod which has a main body and a cap that are connected to each other with sufficient strength.

Another object of the present invention is to provide a method of manufacturing the above connecting rod.

According to an aspect of the present invention, there is provided a connecting rod comprising a large end having a first through hole defined therein, a small end having a second through hole defined therein which is smaller in diameter than the first through hole, and an elongate shank interconnecting the large end and the small end, wherein the large end is divided into members, and the divided members of the large end are connected to each other, and wherein a martensitic structure is provided in the divided region of the large end.

According to the present invention, the martensitic structure is provided in the divided region. The large end can easily be fractured by developing brittle fracture in the martensitic structure.

In the connecting rod, preferably, the proportion of carbon in a region free of the martensitic structure is 0.1 weight % or greater, and the martensitic structure has a Rockwell C-scale hardness (HRC) of 30 or greater. With this configuration, brittle fracture reliably starts from the martensitic structure.

According to another aspect of the present invention, there is provided a method of manufacturing a connecting rod, comprising the steps of:

producing a preform integrally having in one member a large end having a first through hole defined therein, a small end having a second through hole defined therein which is smaller in diameter than the first through hole, and an elongate shank interconnecting the large end and the small end;

transforming a to-be-divided region of the large end into a martensitic structure;

applying a fracturing load to the to-be-divided region of the martensitic structure to fracture the large end from the to-be-divided region; and

interconnecting fractured members of the large end.

The martensitic structure is generally of high hardness and hence low toughness, and is susceptible to brittle fracture. Therefore, the large end can easily start to be fractured from the martensitic structure. Since the other region than the martensitic structure is not subject to brittle fracture, the large end can reliably be fractured from the given to-be-divided region.

Since the large end is easily fractured, the fracturing load can be low. Accordingly, a fracturing device may be small in size, and the investment in facilities can be low.

As only the to-be-divided region is transformed into the martensitic structure, the preform and hence the entire connecting rod is prevented from becoming brittle.

According to the present invention, as described above, the martensitic structure is developed in the to-be-fractured region, and brittle fracture is caused to occur in the martensitic structure, thereby dividing the large end. Consequently, since the fracturing load may be low, the fracturing device can be small in size, and the investment in facilities can be low.

As the other region than the martensitic structure is not subject to brittle fracture, the large end can reliably be fractured from the given to-be-divided region.

In addition, there is no need to perform a complex process of providing protrusions and then compressing the protrusions, the efficiency with which the connecting rod to be produced is not lowered.

Since it is not necessary to provide a notch in the to-be-divided region, the number of steps is reduced and the connecting rod is produced with increased efficiency. As no notch forming device is required, the connecting rod is advantageous in terms of cost.

A notch may be provided in advance in the to-be-divided region. In this case, a bottom of the notch may be transformed into the martensitic structure. With the notch being provided, the large end does not start to be fractured from other regions than the notch, and no notch remains in the connecting rod as a final product. Therefore, a connecting rod free of a remaining notch is obtained, and the fabrication yield of connecting rods is greatly increased.

The martensitic structure may be developed in the to-be-divided region by a highly simple process of applying a laser beam or a plasma to the to-be-divided region, for example.

The preform (PR) is preferably made of a steel material wherein the proportion of carbon is 0.1 weight % or greater. The produced martensitic structure exhibits a relatively high hardness, i.e., has a HRC of 30 or greater. Since the region of such a high hardness is susceptible to brittle fracture, it is easier to fracture the large end.

### BRIEF DESCRIPTION OF THE DRAWINGS

FIG. 1 is a front elevational overall view of a connecting rod according to an embodiment of the present invention;

FIG. 2 is an enlarged fragmentary cross-sectional view of a region near a notch defined in the connecting rod shown in FIG. 1;

FIGS. 3A through 3E are flow diagrams showing a process of manufacturing the connecting rod shown in FIG. 1;

FIG. 4 is an enlarged fragmentary cross-sectional view of a region including a notch with a curved bottom;

FIG. 5 is an enlarged fragmentary cross-sectional view of a to-be-fractured region according to another embodiment of the present invention;

FIG. 6 is a perspective overall view of a conventional connecting rod; and

FIG. 7 is a perspective overall view of a preform to be fractured.

### BEST MODE FOR CARRYING OUT THE INVENTION

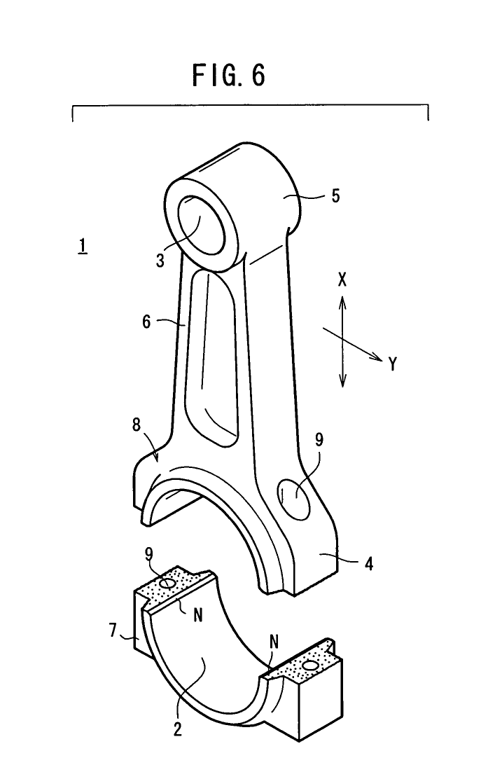

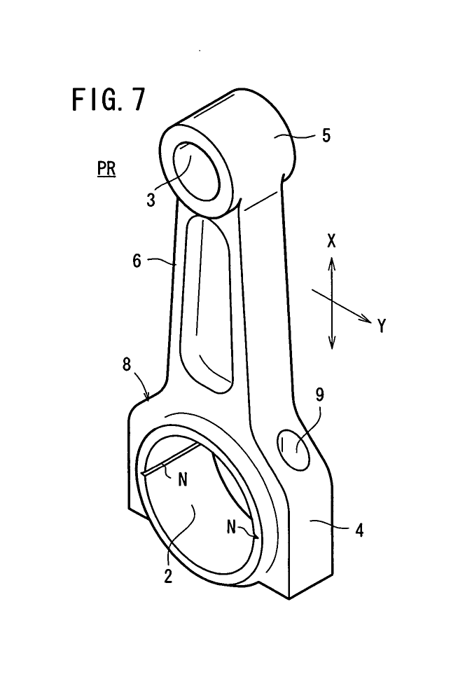

Preferred embodiments of a connecting rod according to the present invention and a method of manufacturing the connecting rod will be described below in detail with reference to the accompanying drawings. Components which are identical to those shown in FIGS. 6 and 7 are denoted by identical reference characters, and will not be described in detail below.

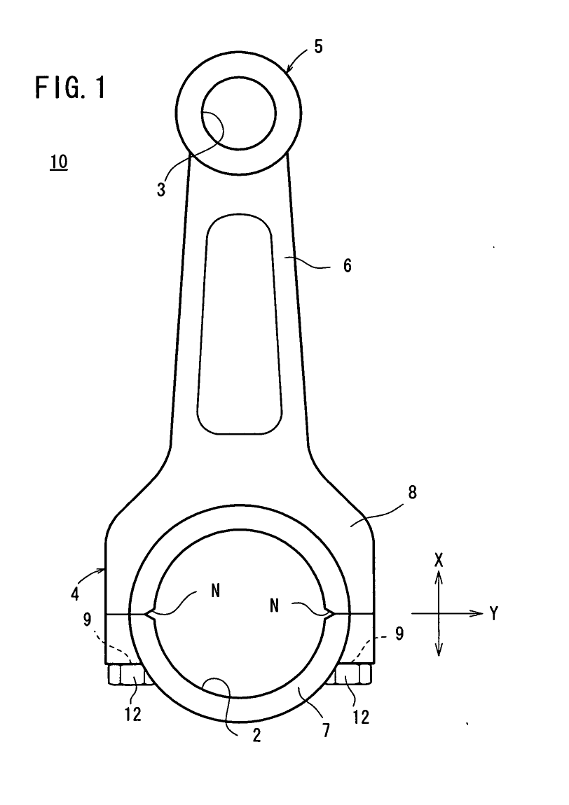

FIG. 1 is a front elevational overall view of a connecting rod 10 according to an embodiment of the present invention. The connecting rod 10 has a large end 4 with a first through hole 2 defined therein, a small end 5 with a second through hole 3 defined therein which is smaller in diameter than the first through hole 2, and a shank 6 interconnecting the large end 4 and the small end 5.

The connecting rod 10 is made of a steel material wherein the proportion of carbon is 0.1 weight % or greater, e.g., chromium-molybdenum steel.

The large end 4 is fractured substantially centrally across the first through hole 2 in a direction (Y direction) perpendicular to the longitudinal direction (X direction in FIG. 1) of the connecting rod 10, thereby dividing the connecting rod 10 into a cap 7 and a main body 8. As can be seen from FIG. 1, the large end 4 is divided from notches N, N in the connecting rod 10.

The cap 7 and the main body 8 are connected to each other by bolts 12, 12 inserted through bolt holes 9, 9.

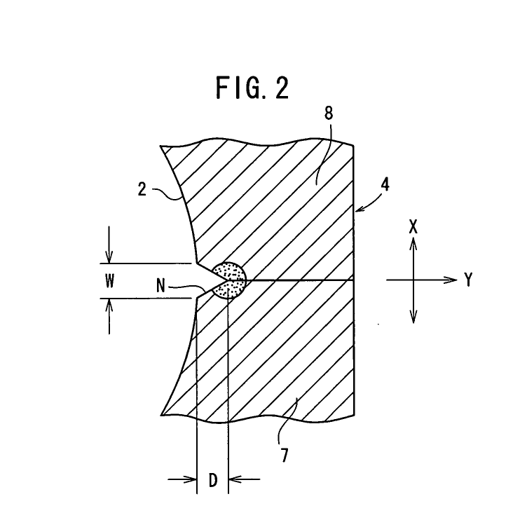

A region near one of the notches N is illustrated at an enlarged scale in FIG. 2. The notch N has a depth D ranging approximately from 0.5 to 0.8 mm and an opening width W ranging approximately from 0.15 to 0.20 mm. The large end 4 is fractured substantially centrally at the bottom of the notch N.

As shown in FIG. 2, a region of martensitic structure (hereinafter referred to as “martensitic region” denoted by 20) is present near the bottom of the notch N. The martensitic region 20 is harder than the other region which is free of a martensitic structure.

Generally, there is a trade-off between hardness and toughness. If one of them increases, the other decreases. Therefore, the martensitic region 20 is lower in toughness than the other region, and hence is relatively susceptible to brittle fracture.

In other words, according to the present embodiment, the martensitic region 20 which is susceptible to brittle fracture is provided in the vicinity of the bottom of the notch N. As described later, the large end 4 is fractured when brittle fracture occurs in the martensitic region 20.

The martensitic region 20 should preferably have an HRC of 30 or greater. If the HRC is less than 30, then toughness increases and brittle fracture is less liable to occur. The HRC should more preferably be 40 or greater. The HRC of the region other than the martensitic region 20 may preferably be about 25 or smaller, but is not limited to that range.

The large end 4 of the connecting rod 10 according to the present embodiment is fractured from the bottoms of the notches N in the Y direction shown in FIG. 1 at the notches N serving as a boundary. The large end 4 is not fractured from other locations than the notches N, N.

The depth D of the notch N is less than 1 mm, and the opening width W thereof is of a small value of about 0.5 mm. Therefore, the area of contact between the cap 7 and the main body 8 is large enough to maintain the strength with which the cap 7 and the main body 8 are interconnected.

The connecting rod 10 is manufactured as follows:

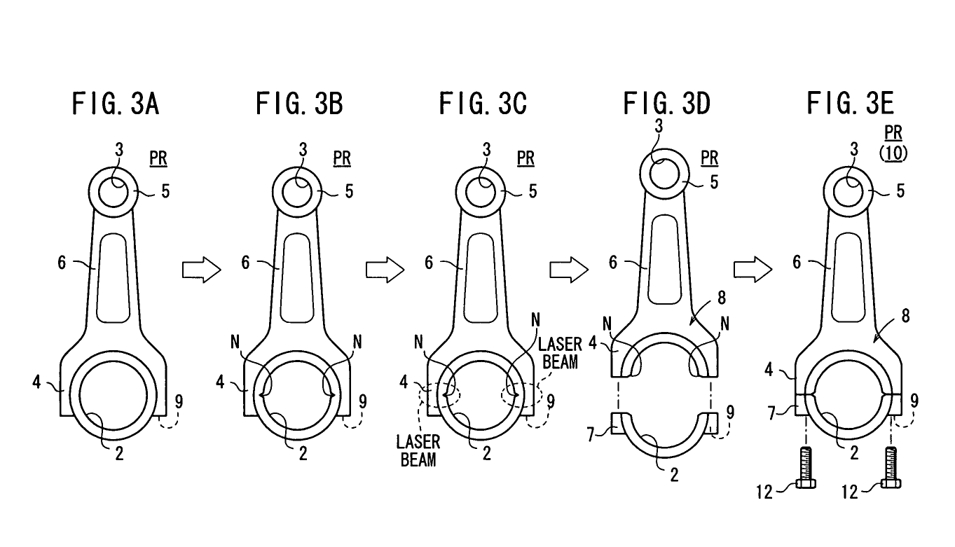

As shown in FIG. 3A, a workpiece preferably made of chromium-molybdenum steel wherein the proportion of carbon is 0.1 weight % or greater and the HRC is less than 25 is forged into a preform PR.

Then, as shown in FIG. 3B, notches N, N are formed in portions substantially at the center of the first through hole 2 defined in the large end 4 of the preform PR.

Then, a martensitic structure is formed in the vicinity of the bottoms of the notches N, N. Specifically, the portions of the preform PR near the bottoms of the notches N, N are selectively heated and then quenched, transforming an austenitic structure in the vicinity of the bottoms of the notches N, N into a martensitic structure.

The portions of the preform PR near the bottoms of the notches N, N may be selectively heated by any desired processes. For example, as shown in FIG. 3C, a laser beam is intensively applied. The laser beam is applied to the depth depending on the thickness of the preform PR, though the depth of about 0.12 mm is sufficient. Instead of the laser beam, a plasma may be applied.

After the portions near the bottoms of the notches N, N are heated to a high temperature by the laser beam or plasma, the application of the laser beam or plasma is stopped, and the portions are cooled in the atmosphere. As the portions are cooled, a martensitic transformation occurs, generating the martensitic region 20 (see FIG. 2). With the preform PR being made of a steel material wherein the proportion of carbon is 0.1 weight % or greater, the HRC of the martensitic region 20 is 30 or greater.

Then, the preform PR is not tempered, but is fractured as shown in FIG. 3D. If the preform PR is tempered, then the toughness of the martensitic region 20 is increased, and the martensitic region 20 is less susceptible to brittle fracture.

When a load is applied to fracture the preform PR, brittle fracture occurs in the martensitic region 20. Specifically, the martensitic region 20 starts to crack from the notches N, N. The crack is progressively propagated until finally the large end 4 is divided into the cap 7 and the main body 8 (see FIG. 2).

Since the martensitic region 20 is subject to brittle fracture, the fracturing load applied to produce and propagate a crack can be smaller than with the conventional art. Stated otherwise, the fracturing apparatus may be small in size, and hence the investment in facilities can be reduced.

Finally, as shown in FIG. 3E, the cap 7 and the main body 8 are connected to each other by the bolts 12, 12, providing the connecting rod 10.

According to the present embodiment, as described above, brittle fracture is caused to occur only in the vicinity of the bottoms of the notches N, N by a simple process of providing the martensitic structure 20 in the vicinity of the bottoms of the notches N, N where the large end 4 starts to be fractured. In other words, because a structure for inviting brittle fracture is not produced in the other region, the notches N, N reliably serve as fracture-starting points, allowing the large end 4 to be easily fractured. Therefore, the large end 4 is not fractured from regions other than the notches N, N, and the notches N, N do not remain in the manufactured connecting rod 10. As a consequence, the fabrication yield of connecting rods 1 is not lowered.

Furthermore, as described above, the depth D of the notch N is less than 1 mm, and the opening width W thereof is about 0.5 mm. Therefore, the area of contact between the cap 7 and the main body 8 produced after the large end 4 is fractured is prevented from being reduced, and hence the strength with which the cap 7 and the main body 8 are interconnected is not reduced.

In the above embodiment, the connecting rod 10 is made of chromium-molybdenum steel. However, the material of the connecting rod 10 is not limited to chromium-molybdenum steel, but may be nickel-chromium-molybdenum steel.

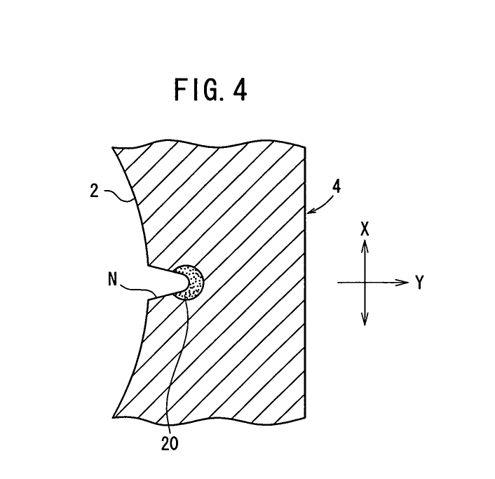

The bottom of the notch N does not need to be of a sharp angle, but may be curved as shown in FIG. 4.

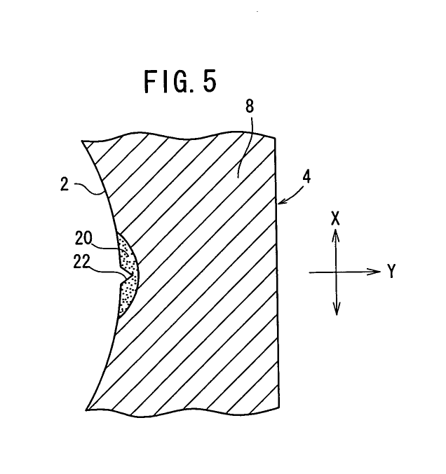

Moreover, there is no need to provide the notches N in particular. Specifically, as shown in FIG. 5, a to-be-divided region may be irradiated with a laser beam or plasma to provide a martensitic region 20, and thereafter the martensitic region 20 may be subject to brittle fracture to produce and propagate a crack.

The region irradiated with the laser beam or plasma is slightly etched by the laser beam or plasma, providing a cavity 22 having a depth ranging approximately from 100 to 200 μm. When the preform PR is divided into the cap 7 and the main body 8, the preform PR starts to be fractured from the cavity 22, from which a crack is propagated to facilitate the fracture.

In this case, since it is not necessary to use a notch forming device to provide the notch N, the number of steps is reduced and the investment in facilities is reduced. Consequently, the connecting rod 10 is produced with increased efficiency, and is advantageous in terms of cost.

1. A connecting rod comprising a large end having a first through hole defined therein, a small end having a second through hole defined therein which is smaller in diameter than said first through hole, and an elongate shank interconnecting said large end and said small end;
wherein said large end is divided into members, and the divided members of said large end are connected to each other; and
wherein a martensitic structure is provided in the divided region of said large end.

2. A connecting rod according to claim 1, wherein the proportion of carbon in a region free of said martensitic structure is 0.1 weight % or greater, and said martensitic structure has a Rockwell C-scale hardness of 30 or greater.

3. A connecting rod according to claim 2, wherein said connecting rod is made of chromium-molybdenum steel or nickel-chromium-molybdenum steel.

4. A method of manufacturing a connecting rod, comprising the steps of:
producing a preform integrally having in one member a large end having a first through hole defined therein, a small end having a second through hole defined therein which is smaller in diameter than said first through hole, and an elongate shank interconnecting said large end and said small end;
transforming a to-be-divided region of said large end into a martensitic structure;
applying a fracturing load to said to-be-divided region of said martensitic structure to fracture said large end from said to-be-divided region; and
interconnecting fractured members of said large end.

5. A method according to claim 4, wherein a notch is provided in advance in said to-be-divided region, and a bottom of said notch being transformed into said martensitic structure.

6. A method according to claim 4, wherein said to-be-divided region is irradiated with a laser beam or plasma to form said martensitic structure.

7. A method according to claim 4, wherein said preform is made of a steel material in which the proportion of carbon is 0.1 weight % or greater, and said martensitic structure has a Rockwell C-scale hardness of 30 or greater.

8. A method according to claim 7, wherein said preform is made of chromium-molybdenum steel or nickel-chromium-molybdenum steel.

9. A method according to claim 5, wherein said to-be-divided region is irradiated with a laser beam or plasma to form said martensitic structure.

10. A method according to claim 5, wherein said preform is made of a steel material in which the proportion of carbon is 0.1 weight % or greater, and said martensitic structure has a Rockwell C-scale hardness of 30 or greater.

11. A method according to claim 6, wherein said preform is made of a steel material in which the proportion of carbon is 0.1 weight % or greater, and said martensitic structure has a Rockwell C-scale hardness of 30 or greater.
